(19) United States
(12) Patent Application Publication
(10) Pub. No.: US 2021/0122911 A1
(43) Pub. Date: Apr. 29, 2021

(54) FILLED-FILAMENT FOR 3D PRINTING

(71) Applicant: Board of Trustees of Michigan State University, East Lansing, MI (US)

(72) Inventors: Aljoscha ROCH, Holt, MI (US); Yaozhong ZHANG, East Lansing, MI (US)

(73) Assignee: Board of Trustees of Michigan State University, East Lansing, MI (US)

(21) Appl. No.: 17/080,977

(22) Filed: Oct. 27, 2020

Related U.S. Application Data
(60) Provisional application No. 62/927,202, filed on Oct. 29, 2019.

(51) Int. Cl. C08L 47/00; B33Y 30/00; B33Y 70/10; B29C 64/255; B28B 1/00; B22F 3/00

(52) U.S. Cl. CPC C08L 47/00; B33Y 30/00; B33Y 70/10; B29K 2509/02; B28B 1/001; B22F 3/008; B29C 64/255

(57) ABSTRACT

A filled and 3D printable filament is provided. In another aspect, a flexible filament comprises polyisoprene, a polymer and a filler. An aspect of a filament or fiber apparatus includes a flexible filament composition coiled around a spool, the filament or fiber composition further including polyisoprene, a polymer, and a ceramic or metallic filler. Another aspect of a filament or fiber apparatus includes a flexible filament composition further including an isoprene rubber, a polymer, a sintering aid additive, and a ceramic or metallic filler.

### CROSS REFERENCE TO RELATED APPLICATIONS

This application claims priority to U.S. provisional patent application Ser. No. 62/927,202 filed on Oct. 29, 2019, which is incorporated by reference herein.

### BACKGROUND AND SUMMARY

The disclosure relates generally to a filament for additive manufacturing and more specifically to a filled filament for 3D printing.

Three-dimensional (“3D”) printing is a quickly evolving technology. Filaments have been used for 3D printing such as those disclosed in the following U.S. Pat. No. 10,434,702 entitled “Additively Manufactured Part Including a Compacted Fiber Reinforced Composite Filament” which issued to Mark et al. on Oct. 8, 2019; U.S. Pat. No. 10,391,714 entitled “Supports for Sintering Additively Manufactured Parts” which issued to Mark on Aug. 27, 2019; and U.S. Pat. No. 10,376,956 entitled “Extrudable Mixture for Use in 3D Printing Systems to Produce Metal, Glass and Ceramic Articles of High Purity and Detail” which issued to Woods on Aug. 13, 2019. All of these patents are incorporated by reference herein.

Traditionally, prior 3D printing filaments are overly brittle and cannot be fed into a printing head from a spool, if the filaments include an additive filler. Furthermore, known attempts to fill a 3D printing filament undesirably cause finished manufactured part bloating, sagging and deformation during a thermal debinding and sintering process. Therefore, there is a need to create a 3D printable filament that is filled, yet has flexibility, and maintains the desired manufactured part shape and dimensions during debinding and sintering.

In accordance with the present invention, a filled and 3D printable filament is provided. In another aspect, a flexible filament comprises polyisoprene, a polymer and a filler. A further aspect includes a metallic and/or ceramic filler. Yet another aspect of a filament usable for additive manufacturing includes: a thermoplastic polymer such as polypropylene, polymethylmethacrylat, polyamide, polystyrene, high density or other polyethylene; polyisoprene; a binder; and metallic and/or ceramic particles. An aspect of a filament or fiber apparatus includes a flexible filament composition coiled around a spool, the filament or fiber composition further including polyisoprene, a polymer, and a ceramic or metallic filler. Another aspect of a filament or fiber apparatus includes a flexible filament composition further including an isoprene rubber, a polymer, a sintering aid additive, and a ceramic or metallic filler. Methods of making and/or using a filled filament for additive manufacturing are also provided. Additional advantageous and features of the present apparatus and method will become apparent from the following description and appended claims, taken in conjunction with the accompanying drawings.

### BRIEF DESCRIPTION OF THE DRAWINGS

FIG. 1 is a diagrammatic view showing the present filament used in an additive manufacturing process;

FIG. 2 is a diagrammatic view showing a process for making the present filament;

FIGS. 3A-3D are a series of diagrammatic views showing the present filament used in an additive manufacturing process;

FIG. 4 is a perspective view showing the present filament; and

FIG. 5 is a graph showing bending deflection of the present filament.

### DETAILED DESCRIPTION

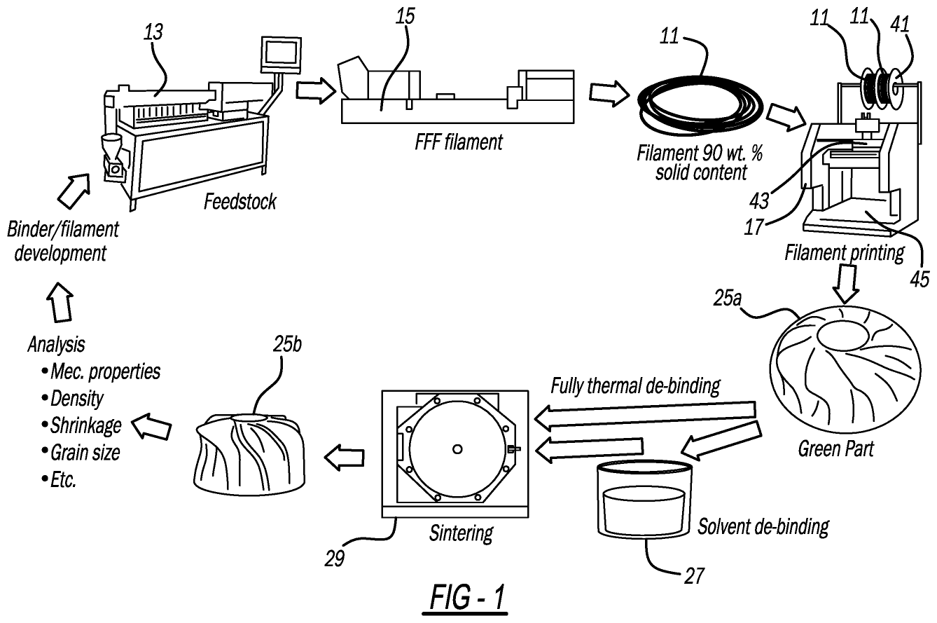

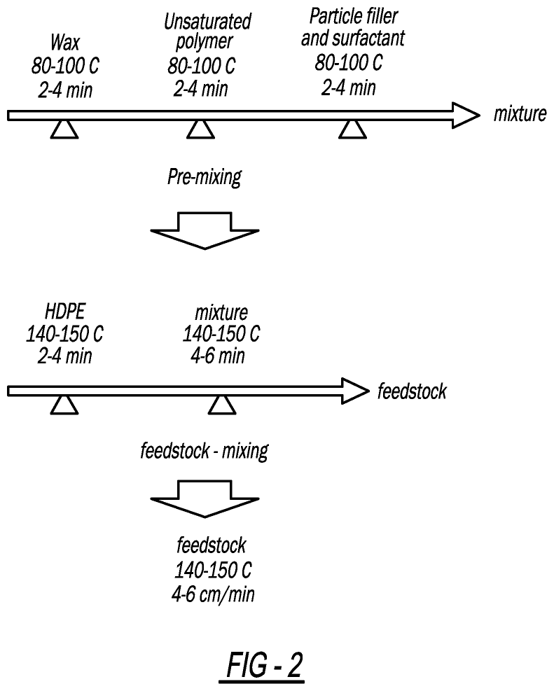

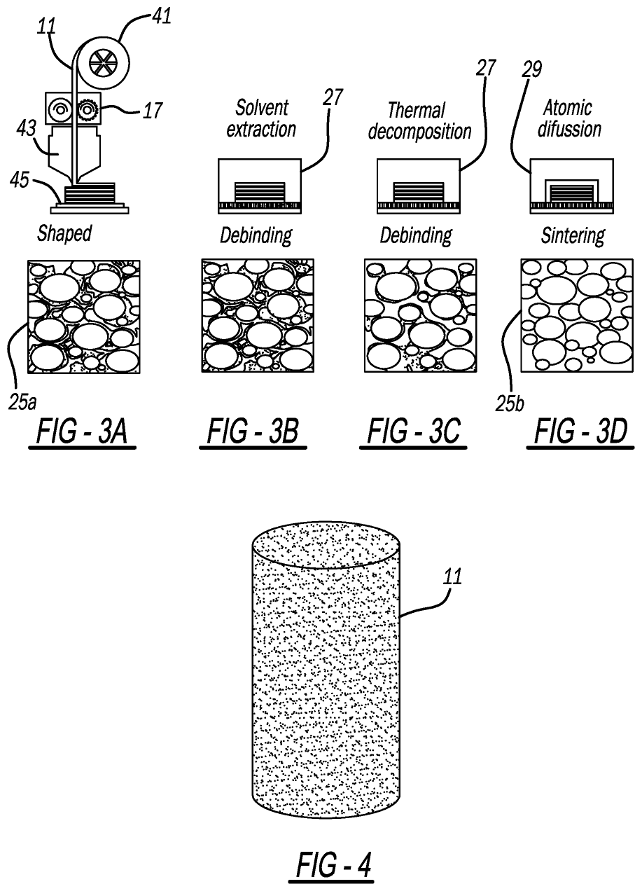

A filled filament 11 for use in additive manufacturing, such as 3D printing, is shown in FIGS. 1-4. A formulation including metal or ceramic particles in a polymer matrix with waxes, surfactants and other additives is melt mixed in an extruder 13 or similar mixing equipment and fed into another extruder 15 to generate a filament of uniform diameter for use in an additive manufacturing machines, such as a fused filament fabrication (“FFF”) 3D printer 17 to form a “green” (i.e., partially cured) part 25a with a green product shape. Subsequently, the product will then be debinded (i.e., the binder is removed) in a debinding station 27 and sintered in a sintering machine 29 into a dense metal or ceramic final manufactured part 25b for industrial or other applications, such as a gear, turbine vanes or the like. An unsaturated low molecular weight (>10K g/mol) linear polymer provides unexpected flexibility in the filament (shown in FIG. 4) which allows it to be used in conventional and inexpensive FFF-based 3D printers. An example of such a polymer would include, but is not limited to, a diene class of polymers like polyisoprene or an isoprene rubber.

An example of a filled filament, includes:
80 to 99% weight percent metal or ceramic particles of 0.1 to 40 microns in size, and even 0.01 to 100 microns in size;
8 parts thermal plastic polymer (e.g., HDPE high density polyethylene)—optionally using multiple polymers of different characteristics (e.g. molecular weight, melting point, viscosity);
2 parts unsaturated linear polymer (e.g., polyisoprene approximately 35K g/mole wt);
2 parts of a low molecular weight wax (e.g., paraffin)—optionally using multiple waxes of different characteristics (e.g., molecular weight, melting point, viscosity);
0.5 wt percent surfactant (e.g., steric acid)—note about 1 mg per square meter of metal of ceramic particle surfaces—BET type isotherms can be used to measure particle surface areas; and
Potential of other additives including sintering aides, debinding aides (e.g., salts), etc.

Surprisingly in conventional approaches, with a saturated linear polymer, the resulting highly filled metal or ceramic extruded filament would be brittle and not able to feed continuously into standard FFF 3D printer. But, with an unsaturated linear polymer additive of the present compound, the filament, even at higher particle loading, is flexible enough to be used with the 3D printer machine with no modifications. For example, at lower particle loading (e.g., 60% by weight) the additive is not required, but upon sintering the part would lose its shape by sagging, or other mechanisms. It is desired to work at the highest loading of metal or ceramic particles possible.

Also, surprisingly, with the present additive, the filling of the metal or ceramic particles can also be higher than without the additive. This is desired to minimize shrinkage during the sintering step. The higher the particle loading the lower the shrinkage on sintering, and a higher mechanical strength will develop in the final part. It is also noteworthy that the unsaturated additive combined with higher loadings of metal and ceramic particles synergistically reduces and potentially eliminates sag of part features during sintering operations. There is also the potential of adding in reactive initiators (e.g., peroxides) that will further allow a crosslinking of the unsaturated polyisoprene forming a network consisting of the metal or ceramic particles with the (nonmeltable) crosslinked polymer chains.

Cis-1,4-polyisopren is used for the filaments as a reactive plasticizer. When this polymer is crosslinked by a so-called vulcanization process, it becomes strong and very flexible and usable for many applications. Initially (before crosslinking), it is a viscous, sticky liquid. More specifically, cis-1,4-polyisopren with a 35 k molecule length is employed. In this form, it is a liquid, however, larger molecules of cis-1,4-polyisopren may not be a liquid but instead in a solid (pellets) form. The advantage of the initial non-crosslinked form is that it can be processed more easily. Furthermore, it can be used as a plasticizer for the thermoplastic polymers. As soon as it is crosslinked, it becomes a thermosetting polymer and cannot be further processed or melted again.

The filaments include the non-crosslinked cis-1,4-polyisopren incorporated into a polymer-wax-metal particle matrix by compounding of all the materials within a twin-screw extruder. The unexpected flexibility is believed to be caused by a crosslinking-effect. The rubber-like flexible behavior of the filament increases with increasing compounding time (for example, >15 min) at 150° C. The more flexible the filament is, the more difficult is it to melt it. Highly flexible filaments do not melt at all at 200° C., for example.

Thus, the following should be considered:
High PI content (>2 parts): leads to high flexibility, but the filament loses meltability and cannot be processed. Compounding time and temperature affect the “crosslinking”.
Medium PI content (1-2 parts): the filament can be printed, but long processing times>20 min at 150° C. are not beneficial.
Preferably, the best amount of PI is far less than 1 part, such as 0.01 part: even when this amount is fully crosslinking, the amount of rubber is still too little to compromise the meltability and processability but high enough to support the mechanical properties.

The crosslinking might also explain the minimal manufactured product sagging in the furnace during thermal debinding and sintering. When the printed and crosslinked polymer does not melt, the printed parts maintain better shape in the furnace. Crosslinking might also be intensified during the thermal treatment in the furnace. If the crosslinking is the reason for the high flexibility, it probably prevents the recrystallization of the melted polymers such as HOPE when the HOPE cools down from 150° C. to room temperature. The crosslinked network is preventing the HOPE from forming larger crystals. Thus, the prevention of HOPE-recrystallization is additionally supporting the flexibility because smaller crystals of HOPE in the filament means higher flexibility.

Another explanation for the high flexibility is: cis-1,4-polyisopren forms covalent bindings to metal particles and can create with metal particles a covalent network. In this case, the cis-1,4-polyisopren is forming a flexible network of metal particles, connected by the cis-1,4-polyisoprene. Ceramic filaments are much less flexible than metal filaments. However, ceramic is usually cubic which is more difficult to process than spherical metal particles, which might be another explanation for the lower flexibility of the ceramic filaments.

With the given proportion of HDPE, polyisoprene, paraffin and stearic acid, the binder system works with 95 wt % stainless steel particles (˜20 μm in mean diameter) and 82 wt % ceramic powders (˜5 μm in mean diameter), respectively. The corresponding structures retain the desired shape after debinding and sintering processes. After the binder/powder filament composition is shaped into a green part by the 3D printer, the binder solvent is extracted and removed, and thermal decomposition occurs in the debinding station. Then the part is moved to the sintering machine when it is heated to create a hardened final metal shape using atomic diffusion. The entire process may cause the manufactured part to shrink depending on the material components employed. The exemplary single sintering step avoids complications otherwise due to cyclical melting and heating of new and underlying layers, thereby reducing or eliminating the formation of interlayer seams, extended columnar grains and build-dependent phase shifts.

As a comparison, a conventional binder system without the unsaturated linear polymer (polyisoprene), exhibits extreme stiffness and fragility. The fabricated filament with the same particle filling tended to break readily in printing process. By decreasing the particle filling (e.g., ˜50 wt % stainless steel and ˜30 wt % ceramic powders), the binder system possesses comparable flexibility with the proposed recipe. However, with this prior attempt, the conventional structures deformed and collapsed in thermal sintering. The abovementioned two examples demonstrated the present improvement of the unsaturated linear polymer in flexibility and particle loading in filament fabrication.

Chemical: δ h (MPa½):
Polyisoprene: 16.5
HDPE: 16.7
Paraffin wax: 18.7 estimated based on being completely soluble in Benzene
   It is believed that the mechanism might also be related to the unsaturated bonds in polyisoprene reacting with metal particles or it is suppressing crystallinity in HPDE.

The current filament composition improves the flexibility of the PE-based filaments, and optimizes the densification (due to minimal shrinkage resulted by higher particle loading) of their finished parts. Furthermore, the binder system is compatible to metal and ceramic powders, which also allows use of the filled filament to multi-materials 3D printing process, such as metal-ceramic heterogeneous structures.

Filler loading of the filament includes ceramic and/or metallic particles as follows:
Ceramic:
In the best case there is 65 vol. % of ceramic particles and 35 vol. % binder

| | |
|---|---|
| 40-75 vol. % | most preferred |
| 35-78 vol. % | more preferred |
| 20-80 vol. % | preferred |

Ceramic particle sized:

| | |
|---|---|
| 20 nm-5 μm | most preferred |
| 15 nm-10 μm | more preferred |
| 10 nm-15 μm | preferred |

Metal:
In the best case there is 85 vol. % of metal particles and 15 vol. % binder:

| | |
|---|---|
| 40-80 vol. % | most preferred |
| 35-82 vol. % | more preferred |
| 30-85 vol. % | preferred |

Metal particle size:

| | |
|---|---|
| 0.5 μm-50 μm | most preferred |
| 1 μm-100 μm | more preferred |
| 1 μm-150 μm | preferred |

It is noteworthy that the metallic filler particles do not have dielectric properties. Thus, in this configuration, the filament is free of dielectric filler particles, and also the filler particles are not surface treated or coated.

Polyisoprene (PI) vs. the other binder components (e.g., HDPE, paraffin, surfactants):

| PI | HDPE, Paraffin, Surfactants: | |
|---|---|---|
| 0.01 | 12.99 | parts |
| 0.1 | 12.9 | parts |

| | | | |
|---|---|---|---|
| 0.5 | parts | 12.5 | parts |
| 1 | part | 12 | parts |
| 2 | parts | 11 | parts |
| 3 | parts | 10 | parts |

*with “parts” is usually meant weight relation. That means the PI amount in the binder can have just 3.8 wt. % for the combination 0.5 PI + 12.5 other polymers (HDPE, paraffin, surfactants).

Flexibility: Including PI enables bending of 1.75 mm diameter filament or 2.85 mm diameter filament around a spool 41 with a diameter of 9.5 cm. Spool 41 is attachable to 3D printing machine 17 to allow flexible feeding of filament or fiber 11 into a movable printing head 43 which melts and emits the filament composition in additive layers upon a stationary or movable table 45. Without PI, this bending is not possible since the filament breaks.

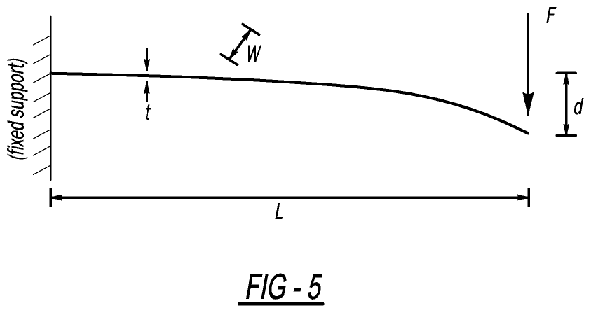

Referring to FIG. 5, a deflection with a L=4 cm long fiber of PI-improved filament shows:

| | |
|---|---|
| d = 1-10 cm | most preferred |
| d = 2-6 cm | more preferred |
| d = 3-5 cm | preferred |

The brittle filament without PI breaks at d=0.5 cm. The flexible filament can bend at d=5 cm without breaking. In this particular case, the filaments have a 2.85 mm diameter.

The present apparatus is flexible at room temperature before melting in an additive manufacturing machine, and the fiber has a mono-modal diameter distribution of the filler therein. In an alternate configuration, the present apparatus includes an additively printable or layerable ink or paste composition including polyisoprene, a thermoplastic polymer, and ceramic or metallic filler particles, plus optional debinding and sintering additives, plus optional pigments.

The present flexible and filled filament apparatus is ideally suited for manufacturing rigid and durable parts such as elongated and hollow pipes, hollow extrusion dies, rotatable turbine blades with a hollow central hub, rotatable gears having teeth and hollow central hubs, rotatable propeller blades, and the like. Furthermore, the present flexible and filled filament apparatus can be used to manufacture medical and biological scaffolds of a mesh like nature with holes therein, and other biomedical implants.

While an example of the present filled filament, method of manufacturing the filament, and method of using the filament have been disclosed, it should be appreciated that variations are envisioned. For example, the present compound and method can alternately be used for injection molding or extrusion molding, although some of the present advantages may not be achieved. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The invention claimed is:

1. A filament apparatus comprising a flexible filament composition coiled around a spool, the filament composition further comprising:
(a) polyisoprene;
(b) a thermoplastic polymer; and
(c) a ceramic or metallic filler.

2. The apparatus of claim 1, wherein the filler is 30-65 weight percent ceramic.

3. The apparatus of claim 1, wherein the filler is 50-90 weight percent metal, the filament composition is free of dielectric filler particles, and the filler is not surface treated or coated.

4. The apparatus of claim 1, further comprising a 3D printing machine flexing, melting and additively depositing the filament composition therein.

5. The apparatus of claim 1, further comprising a low molecular weight wax and a surfactant, and the thermoplastic polymer is at least one of: polypropylene, polymethylmethacrylat, polyethylene, polyamide, or polystyrene.

6. The apparatus of claim 1, further comprising a sintering aid additive.

7. The apparatus of claim 1, further comprising a debinding aid additive.

8. The apparatus of claim 1, wherein the filler comprises 80 to 99 weight percent metal or ceramic particles of 0.04 to 40 microns in size.

9. The apparatus of claim 1, wherein the filler comprises 80 to 99 weight percent metal or ceramic particles of 0.01 to 150 microns in size.

10. The apparatus of claim 1, further comprising:
an additive manufacturing machine to which the spool is attached to allow flexible feeding of the filament composition from the spool; and
the additive manufacturing machine being configured to create a green part therein after which the green part is configured to be solvent de-binded and then sintered.

11. The apparatus of claim 1, wherein the filament composition comprises one part polyisoprene to twelve parts of a combination of: the thermoplastic polymer, a paraffin and surfactants.

12. A filament apparatus comprising a flexible filament composition, the filament composition further comprising:
(a) isoprene rubber;
(b) at least one polymer of: polymethylmethacrylat, polyethylene, polypropylene, polyamide, or polystyrene;
(c) a sintering aid additive; and
(d) a filler comprising at least one of:
(i) 35-78 volume percent ceramic particles; or
(ii) 30-85 volume percent metal particles.

13. The apparatus of claim 12, wherein the filler comprises ceramic particles of 20 nm-20 μm in size.

14. The apparatus of claim 12, wherein the filler comprises metal particles of 90 nm-50 pm in size, the filament composition is free of dielectric filler particles, and the filler is not surface treated or coated.

15. The apparatus of claim 12, further comprising a 3D printing machine flexing, melting and additively depositing the filament composition therein, and the isoprene rubber includes vulcanized Cis-1,4-polyisopren.

16. The apparatus of claim 12, further comprising an additive manufacturing machine spool around which the filament composition is coiled.

17. The apparatus of claim 12, wherein the filament composition comprises one part polyisoprene to twelve parts of a combination of: the polyethylene, a paraffin and surfactants.

18. The apparatus of claim 12, wherein the filament composition is melted to create an additively layered, rigid and rotatable part including a hollow center.

19. In combination, a flexible fiber coiled around an additive manufacturing spool, the fiber further comprising:
(a) vulcanized Cis-1,4-polyisopren;
(b) at least one polymer of: polypropylene, polyethylene, polymethylmethacrylat, polyamide, or polystyrene;
(c) a sintering aid additive; and
(d) a ceramic or metallic filler;
wherein a 4 cm long piece of the fiber has a bending deflection of at least 1 cm at room temperature.

20. The combination of claim 19, wherein the 4 cm long piece of the fiber has a bending deflection of at least 3 cm at the room temperature before melting in an additive manufacturing machine, and the fiber has a mono-modal diameter distribution of the filler therein.

21. The combination of claim 19, further comprising:
an additive manufacturing machine to which the spool is attached to allow flexible feeding of the fiber from the spool;
the additive manufacturing machine being configured to create a green part therein after which the green part is configured to be solvent de-binded and then sintered; and
the filler comprises at least one of:
(a) 35-78 volume percent ceramic particles; or
(b) 30-85 volume percent metal particles.

22. A composition comprising:
(a) polyisopren;
(b) at least one polymer of: polypropylene, polyethylene, polymethylmethacrylat, polyamide, or polystyrene;
(c) a debinding or sintering additive; and
(d) a ceramic or metallic filler;
wherein the composition has a mono-modal diameter distribution of the filler therein; and
wherein the composition is an additively layerable and meltable ink, paste or filament.
